(19) United States
(12) Patent Application Publication
(10) Pub. No.: US 2017/0019482 A1
(43) Pub. Date: Jan. 19, 2017

(54) METHOD AND APPARATUS FOR DOWNLOADING CONTROL PROGRAM

(71) Applicant: Xiaomi Inc., Beijing (CN)

(72) Inventors: Yuanbo WANG, Beijing (CN); Yi DING, Beijing (CN); Enxing HOU, Beijing (CN)

(73) Assignee: Xiaomi Inc.

(21) Appl. No.: 14/984,423

(22) Filed: Dec. 30, 2015

(30) Foreign Application Priority Data
Jul. 13, 2015 (CN) 201510409111.2

(51) Int. Cl. H04L 29/08

(52) U.S. Cl. CPC H04L 67/125; H04L 67/06

(57) ABSTRACT

A method for a first device to download a control program is disclosed. The method includes: receiving a Local Area Network (LAN) signal sent by a second device to be controlled after the second device enters an Access Point (AP) mode; establishing a LAN connection with the second device according to the LAN signal; and downloading the control program for controlling the second device from the second device through the LAN connection.

### CROSS-REFERENCE TO RELATED APPLICATIONS

This application is based upon and claims priority to Chinese Patent Application No. 201510409111.2, filed Jul. 13, 2015, the entire contents of which are incorporated herein by reference.

### TECHNICAL FIELD

The present disclosure relates to the field of communication and, more particularly, to a method and an apparatus for downloading a control program.

### BACKGROUND

Internet of things is one kind of internet in which a plurality of things is connected. For example, all electronic apparatuses in a household can be connected to internet of things. In internet of things, a user may control individual electronic apparatuses in the household via a mobile phone, which provides convenience to the user. For example, before arriving home after work, the user may control an air conditioner in the household to start cooling the house in advance via the mobile phone so that the user may feel nice and cool once arriving home.

Before using the mobile phone to control the electronic apparatus, the user generally needs to download a control program to the mobile phone for controlling the electronic apparatus. Conventionally, when downloading a control program, the mobile phone of the user needs to be connected to the internet, and then downloads the control program from the internet.

### SUMMARY

According to a first aspect of the present disclosure, there is provided a method for a first device to download a control program. The method includes: receiving a Local Area Network (LAN) signal sent by a second device to be controlled after the second device enters an Access Point (AP) mode; establishing a LAN connection with the second device according to the LAN signal; and downloading the control program for controlling the second device from the second device through the LAN connection.

According to another aspect of the present disclosure, there is provided an apparatus for downloading a control program. The apparatus includes: a processor; and a memory for storing instructions executable by the processor. The processor is configured to: receive a Local Area Network (LAN) signal sent by a device to be controlled after the device enters an Access Point (AP) mode; establish a LAN connection with the device according to the LAN signal; and download the control program for controlling the device from the device through the LAN connection.

According to another aspect of the present disclosure, there is provided a device. The device includes: a processor; and a memory for storing instructions executable by the processor. The processor is configured to: detect a switching instruction; enter an Access Point (AP) mode; broadcast a LAN signal after entering the AP mode; receive an access request message sent by a mobile terminal according to the LAN signal; establish a LAN connection with the mobile terminal; and send a control program for controlling the device to the mobile terminal via the LAN connection.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1A is a flow chart of a method for downloading a control program, according to one exemplary embodiment.

FIG. 1B is a flow chart of a method for downloading a control program, according to another exemplary embodiment.

FIG. 2A is a flow chart of a method for downloading a control program, according to another exemplary embodiment.

FIG. 2B is a schematic diagram of an interface, according to one exemplary embodiment.

FIG. 2C is a schematic diagram of an interface, according to another exemplary embodiment.

FIG. 2D is a schematic diagram of an interface, according to another exemplary embodiment.

FIG. 2E is a schematic diagram of an interface, according to another exemplary embodiment.

FIG. 3A is a block diagram of an apparatus for downloading a control program, according to one exemplary embodiment.

FIG. 3B is a block diagram of an apparatus for downloading a control program, according to another exemplary embodiment.

FIG. 4 is a block diagram of an apparatus for downloading a control program, according to another exemplary embodiment.

FIG. 5 is a block diagram of an apparatus for downloading a control program, according to another exemplary embodiment.

FIG. 6 is a block diagram of an apparatus for downloading a control program, according to another exemplary embodiment.

Specific embodiments in this disclosure have been shown by way of example in the foregoing drawings and are hereinafter described in detail. The figures and written description are not intended to limit the scope of the inventive concepts in any manner. Rather, they are provided to illustrate the inventive concepts to a person skilled in the art by reference to particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with some aspects related to the invention as recited in the appended claims.

Currently, a user utilizes a mobile terminal to download a control program for controlling a device from the internet. However, sometimes the mobile terminal may not be able connect to the internet or cannot download the control program from the internet. In embodiments of the present disclosure, when failing to download the control program from internet, a mobile terminal may use the following methods to download the control program from the device to be controlled.

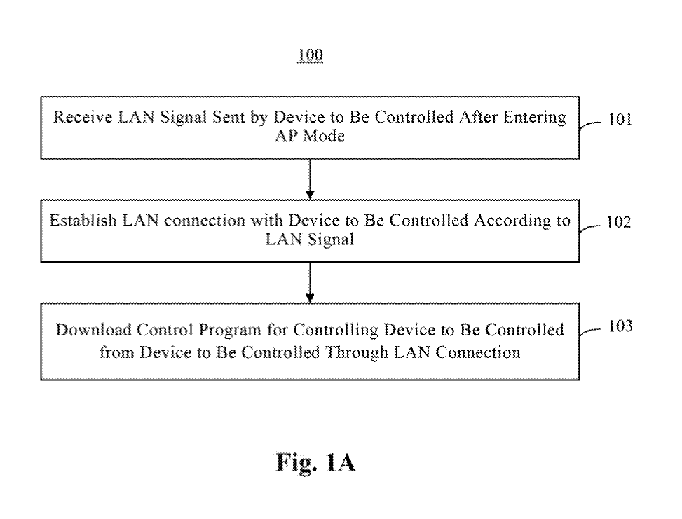

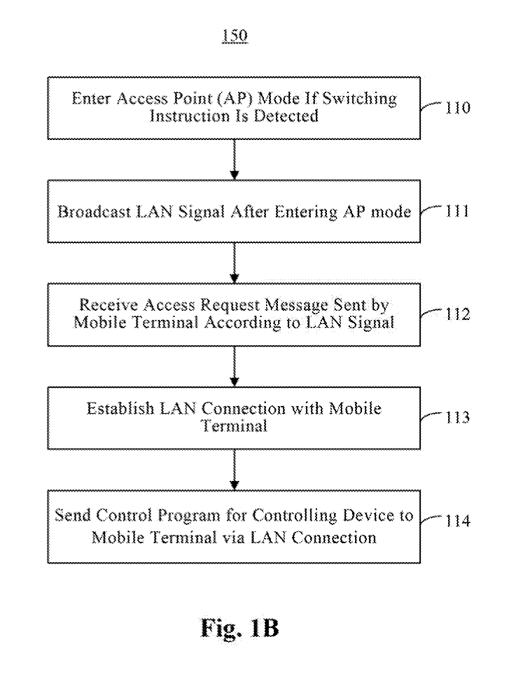

FIG. 1A is a flow chart of a method 100 for downloading a control program, according to one exemplary embodiment. The method 100 may be performed by a mobile terminal and includes the following steps.

In step 101, a LAN (Local Area Network) signal sent by a device to be controlled after entering an AP (Access Point) mode is received.

In step 102, a LAN connection with the device to be controlled is established according to the LAN signal.

In step 103, a control program for controlling the device to be controlled is downloaded from the device to be controlled through the LAN connection.

In exemplary embodiments, in step 101, when it is determined that downloading the control program for controlling the device to be controlled via the internet is unsuccessful, the mobile device receives the LAN signal sent by the device to be controlled after the device entering the AP mode.

Whether the control program is successfully downloaded via the internet may be determined according to pre-set detecting conditions. For instance, when it is detected that there is no router, no network, no authority of accessing internet, the mobile terminal's failure of connecting to the internet, or the like, it can be determined that it is unsuccessful to download the control program via the internet.

In some embodiments, in step 101, when it is determined that downloading the control program via internet is unsuccessful, a notification is issued for notifying a user that downloading the control program via the internet is unsuccessful.

When detecting a user instruction of changing the manner of acquiring the control program, the mobile terminal may receive a LAN signal sent by the device to be controlled after the device entering the AP mode.

Consistent with the embodiments of the present disclosure, by establishing a LAN connection with a device to be controlled, a control program for controlling the device to be controlled can be downloaded from the device to be controlled through the LAN connection. Even if a mobile terminal cannot download a control program for the device to be controlled from the internet, the mobile terminal can download it from the device to be controlled to control the device to be controlled.

FIG. 1B is a flow chart of a method 150 for downloading a control program, according to another exemplary embodiment of the present disclosure. The method 150 may be performed by a device to be controlled and includes the following steps.

In step 110, if detecting a switching instruction, the device to be controlled enters an access point (AP) mode.

In step 111, the device to be controlled broadcasts a LAN signal after entering the AP mode.

In step 112, the device to be controlled receives an access request message sent by a mobile terminal according to the LAN signal.

In step 113, the device to be controlled establishes a LAN connection with the mobile terminal.

In step 114, the device to be controlled sends a control program for controlling the device to be controlled to the mobile terminal via the LAN connection.

In some embodiments, in step 110, the device to be controlled may include a switching means (e.g., a switch button) which, when triggered, causes the device to enter the AP mode. In one embodiment, the device may receive a switching instruction which is triggered by a voice input of the user and causes the device to enter the AP mode.

Consistent with the embodiments of the present disclosure, when the mobile terminal does not successfully download from the internet the control program for controlling the device, the mobile terminal sends an access request message which is received by the device. The device establishes a LAN connection with the mobile terminal, and the control program of the device is sent to the mobile terminal through the LAN connection. Even if the mobile terminal cannot download a control program for controlling the device from the internet, the mobile terminal can download it from the device to control the device.

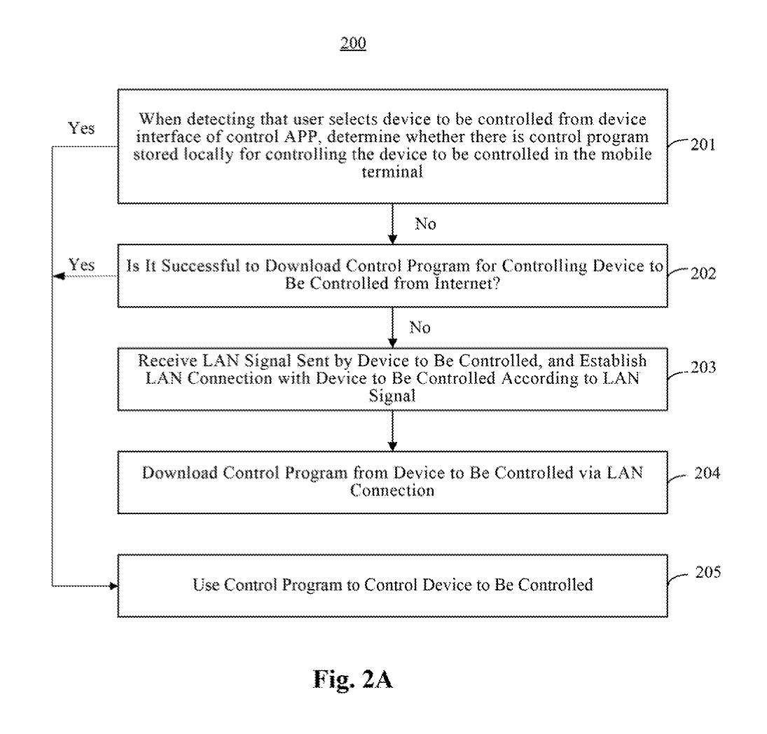

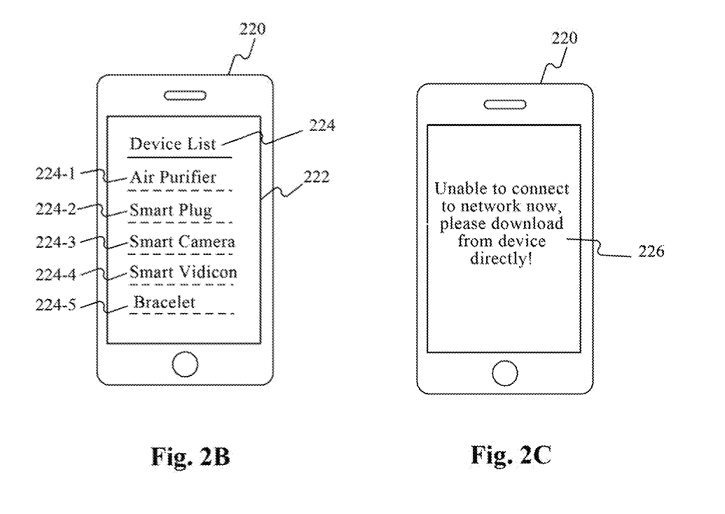

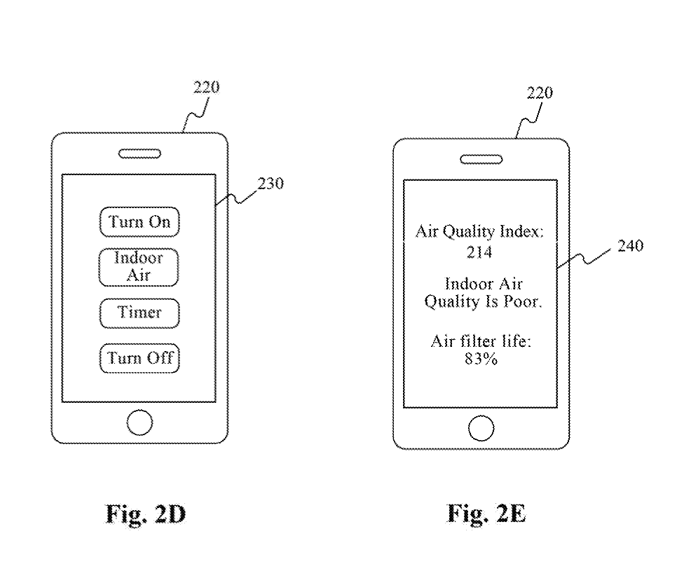

FIG. 2A is a flow chart of a method 200 for downloading a control program, according to an exemplary embodiment. The method 200 may be performed by a mobile terminal. The mobile terminal may be a mobile phone, a tablet, a PDA, or the like. The method 200 for downloading a control program may include the following steps.

In step 201, when detecting that a user selects a device to be controlled from a device interface of a control APP (Application), the mobile terminal determines whether there is a control program for controlling the device to be controlled stored locally in the mobile terminal. If there is no control program for controlling the device to be controlled stored locally in the mobile terminal, the method 200 proceeds to step 202.

In some embodiments, a control APP for controlling devices is installed in the mobile terminal in advance. The control APP includes a device list including various types of devices which can be controlled by the control APP. When the control APP is installed in the mobile terminal, the control APP may control basic functions of the device. For instance, the control APP may control an account between the device and the user, or control the device to connect to a network. The basic functions of the device are functions which can be controlled by the control APP directly.

In the present embodiment, each type of the devices corresponds to a control program which is used for controlling additional functions of the devices in addition to the basic functions. The control program at least includes a control interface and a control command for controlling the device, and each control command corresponds to one function included in the device for controlling the corresponding function. In the present embodiment, in order to enable the mobile terminal to control all the functions of the device, the mobile terminal can download the control program for controlling the device and install it in the control APP. The mobile terminal may then control all the functions of the device through the control APP.

Therefore, in step 201, if the user wants to use the mobile terminal to control all the functions of a certain device, the user may start the control APP in the mobile terminal. The mobile terminal displays a device interface of the control APP. The device interface includes a device list. The user may select one device he wishes to control from the device list. The mobile terminal acquires a user input selecting the device to be controlled, and detects whether there is a control program for controlling the device to be controlled. If there is no control program, step 202 is performed.

If the mobile terminal locally includes a control program for controlling the device to be controlled, in step 205, the mobile terminal uses the control program to control the device to be controlled.

In some embodiments, the mobile terminal displays a control interface included in the control program. The control interface includes at least one control port corresponding to one or more control commands included in the control program. When detecting that the user selects a control port in the control interface, the mobile terminal acquires a control command corresponding to the control port and sends the control command to the device to be controlled such that the device can execute the control command.

For example, FIG. 2B shows an exemplary mobile terminal 220, such as a mobile phone. The mobile terminal 220 displays an exemplary device interface 222 of the control APP. The device interface 222 includes a device list 224 including various types of devices, such as an air purifier 224-1, a smart plug 224-2, a smart camera 224-3, a smart vidicon 224-4, a bracelet 224-5, and the like. After the user starts the control APP in the mobile terminal 220, the mobile terminal 220 displays the device interface 222 of the control APP. The user may select one device as the device to be controlled from the device interface 222. For example, the selected device is an air purifier 224-1. That is, the air purifier 224-1 is the device to be controlled.

The mobile terminal 220 acquires a user selection of the air purifier 224-1, and detects whether there is a control program stored locally for controlling the air purifier 224-1. If there is no control program stored locally for controlling the air purifier 224-1, step 202 is performed.

Referring again to FIG. 2A, in step 202, the mobile terminal 220 tries to download a control program for controlling the device to be controlled from the internet. If it is unsuccessful to download the control program from internet, step 203 is performed.

In one embodiment, the mobile terminal fails to connect to the internet, and thus does not successfully download the control program from the internet. In the embodiments of the present disclosure, the device to be controlled can include a MCU (Microcontroller Unit) including a flash memory for storing a control program of controlling the device to be controlled, such that when the mobile terminal cannot successfully download the control program for controlling the device from the internet, the mobile terminal can download the control program from the device to be controlled.

The control program for controlling the device to be controlled may be a program which is developed based on the fifth amended HyperText Markup Language HTML5. A size of a control program developed by HTML5 can be relative small so that the capacity of the flash memory to store the control program can be relatively small. In addition, since the control program is developed by HTML5, the control program may be compatible with a mobile operating system, such as an iOS platform or an Android platform.

In some embodiments, the control program for controlling the device to be controlled may be in a form of a plug-in, an APK (Android Package) or an APP stored in the flash memory.

Consistent with the embodiments of the present disclosure, if the mobile terminal fails to successfully download the control program from the internet, the device to be controlled can enter an AP mode. In the AP mode, the device to be controlled allows the control program to be downloaded to the mobile terminal.

For example, when the mobile terminal determines that it is impossible to successfully download the control program from the internet, the mobile terminal may display prompt information to notify the user that it is unable to download the control program from the internet. In some embodiments, the device to be controlled includes a switching means, which may be a physical button on the device to be controlled or may be a virtual button displayed on a display screen of the device to be controlled. The user may click the switching means to trigger a switching instruction to the device to be controlled. When detecting the switching instruction, the device to be controlled enters the AP mode. In one embodiment, the user may trigger the switching instruction via a voice input to the device to be controlled. When detecting the switching instruction triggered by the voice input, the device to be controlled enters the AP mode.

In some embodiments, whether a control program can be successfully downloaded from the internet is determined according to detecting conditions set by the user. For example, the user may set that when detecting there is no router, no network, or no authority of accessing internet, failure of connecting to internet by the apparatus, or the like, the mobile terminal may determine that it is unable to download the control program from the internet.

After the device to be controlled enters the AP mode, the device to be controlled becomes an AP for broadcasting a LAN signal to a nearby area, so as to enable the mobile terminal to access the device to be controlled and download the control program from the device to be controlled. For example, after entering the AP mode, the device to be controlled may become a WiFi hotspot and broadcast a WiFi signal around.

For example, referring to FIG. 2C, when the mobile terminal 220 detects that no control program of the air purifier is stored locally, the mobile terminal 220 may try to connect to the internet to download the control program. The mobile terminal 220 may find that it is unable to connect to the internet and display prompt information 226: “Unable to connect to network now, please download from device directly!” The user presses the switching means, which may be a button, on the air purifier. When detecting a switching instruction triggered by pressing the switching means, the air purifier enters the AP mode, sets itself to be a WiFi access point, and broadcasts a WiFi signal to its surroundings.

Referring again to FIG. 2A, in step 203, the mobile terminal receives the LAN signal sent by the device to be controlled, and a LAN connection between the mobile terminal and the device to be controlled is established according to the LAN signal.

The mobile terminal receives a LAN signal sent by the device to be controlled, and sends an access request message to the device to be controlled according to the LAN signal. After receiving the access request message, the device to be controlled sends an access response message to the mobile terminal so as to establish a LAN connection. For instance, the mobile terminal receives a WiFi signal sent by an air purifier, and accesses the air purifier according to the WiFi signal so as to establish a WiFi connection with the air purifier.

In some embodiments, in step 203, when receiving the LAN signal sent by the device to be controlled, the mobile terminal may issue prompt information for notifying the user that it is unsuccessful to download the control program through the internet. When detecting a user instruction for changing the manner of acquiring the control program, the mobile terminal can receive the LAN signal sent by the device to be controlled.

In step 204, the mobile terminal downloads the control program from the device to be controlled via the LAN connection.

The mobile terminal may send a downloading command to the device to be controlled via the LAN connection. The device to be controlled receives the downloading command and sends the control program to the mobile terminal. The mobile terminal receives the control program so as to complete downloading the control program.

After receiving the control program, the mobile terminal may display a control interface included in the control program. The control interface includes at least one control port, and each control port in the at least one control interface is corresponding to one or more control command in the control program. The user may select an interface port so that the mobile terminal acquires a control command corresponding to this control port, and sends the control command to the device to be controlled via the LAN connection. The device to be controlled receives and executes the control command sent by the mobile terminal.

For instance, the mobile terminal may send a downloading command to an air purifier via a WiFi connection. The air purifier receives the downloading command and, in response thereto, sends its control program to the mobile terminal. The mobile terminal receives the control program from the device via the WiFi connection. The control program includes a control interface and a plurality of control commands. As shown in FIG. 2D, a control interface 230 includes four control ports: “Turn On”, “Indoor Air”, “Timer”, and “Turn Off”. A turn-on command corresponds to “Turn On”, an acquiring command for acquiring a quality of indoor air corresponds to “Indoor Air”, a timer command corresponds to “Timer”, and a turn-off command corresponds to “Turn Off”.

After downloading the control program, the mobile terminal 220 displays the control interface 230 shown in FIG. 2D. In one embodiment, the user selects “Indoor Air” in the control interface 230. The mobile terminal 220 acquires the acquiring command corresponding to “Indoor Air” and sends the acquiring command to an air purifier via a WiFi connection. The air purifier receives the acquiring command, acquires the current air quality information, and forwards the acquired air quality information to the mobile terminal 220 via the WiFi connection. The mobile terminal 220 receives the air quality information and is configured to display, e.g., a message 240: “Air Quality Index: 214,” “Indoor Air Quality Is Poor,” and “Air Filter Life: 83%”, as shown in FIG. 2E.

Consistent with the embodiments of the present disclosure, when it is unsuccessful to download the control program for controlling the device to be controlled from the internet, the mobile terminal establishes a LAN connection with the device to be controlled and downloads the control program from the device to be controlled through the LAN connection. Even if the mobile terminal fails to download the control program from the internet, the mobile terminal can download the control program from the device to be controlled to control the device.

Devices consistent with embodiments of the present disclosure are described hereafter, which may be used for performing the methods explained above. The details of the devices may also be referred to in the methods embodiments if they are not illustrated hereafter.

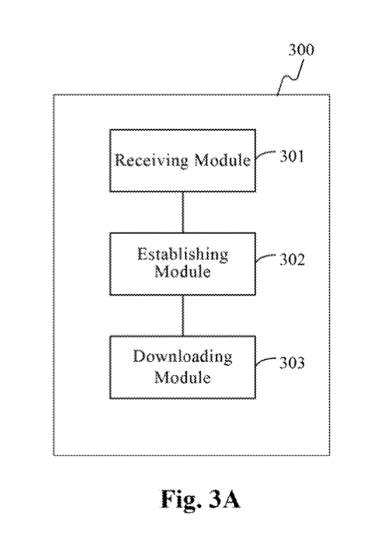

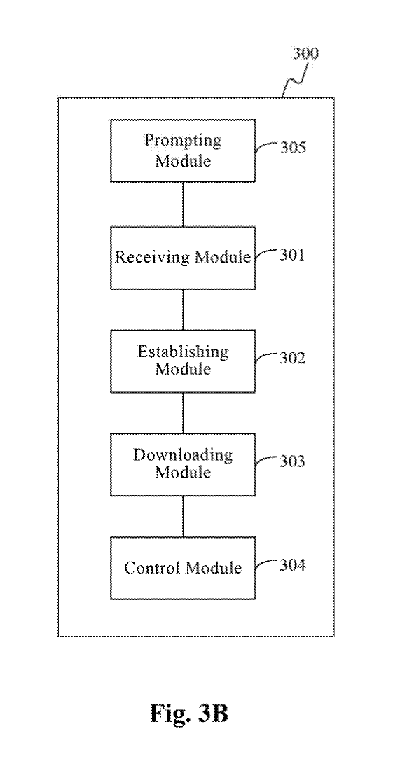

FIG. 3A is a block diagram of an apparatus 300 for downloading a control program, according to one exemplary embodiment. The apparatus 300 may be a mobile terminal, including a receiving module 301, an establishing module 302, and a downloading module 303.

The receiving module 301 is configured to receive a LAN signal sent by a device to be controlled after entering an AP mode.

The establishing module 302 is configured to establish a LAN connection with the device to be controlled according to the LAN signal.

The downloading module 303 is configured to download a control program for controlling the device to be controlled from the device through the LAN connection.

In some embodiments, the control program at least includes a control interface and a command for controlling the device to be controlled. The control interface includes at least one control port corresponding to one or more control commands in the control program.

In some embodiments, referring to FIG. 3B, the apparatus 300 further includes a control module 304.

The control module 304 is configured to receive a user selection of a control port in the control interface, acquire the control command corresponding to the selected control port, and send the control command to the device to be controlled via the LAN, such that the device to be controlled can execute the control command.

In some embodiments, the receiving module 301 is configured to, if it is determined that downloading the control program for controlling the device to be controlled via the internet is unsuccessful, receive the LAN signal sent by the device to be controlled after entering the AP mode.

In some embodiments, referring to FIG. 3B, the apparatus 300 further includes a prompting module 305.

The prompting module 305 is configured to, if it is determined that downloading the control program for controlling the device to be controlled via the internet is unsuccessful, issue prompt information for notifying the user that downloading the control program via the internet is unsuccessful.

The receiving module 301 is configured to, when detecting a user instruction of changing the manner of acquiring control program, receive the LAN signal sent by the device to be controlled after the device enters the AP mode.

In some embodiments, the control program is a program developed based on the fifth amended HyperText Markup Language HTML5, and the control program is compatible with a mobile operating system, such as an iOS platform or an Android platform.

Consistent with the embodiments of the present disclosure, when it is unsuccessful to download the control program for controlling the device to be controlled from the internet, the apparatus 300 establishes a LAN connection with a device to be controlled, and downloads a control program for controlling the device to be controlled from the device through the LAN connection. Even if the apparatus 300 fails to download the control program of the device to be controlled from internet, the apparatus 300 can download it from the device to be controlled and achieve the control to the device.

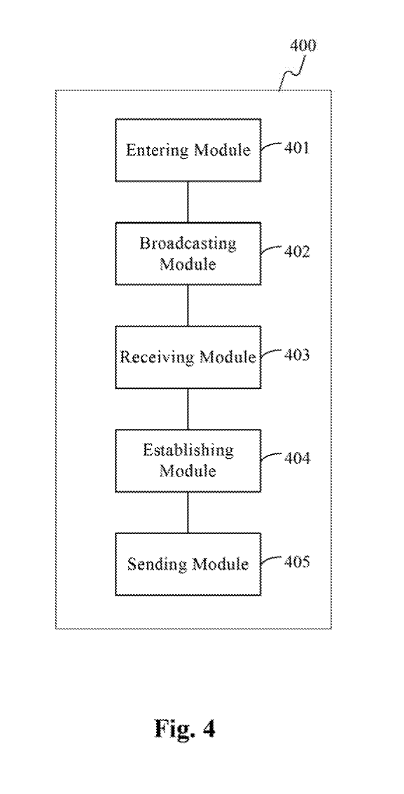

FIG. 4 is a block diagram of an apparatus 400 for downloading a control program, according to an exemplary embodiment. The apparatus 400 may be a device to be controlled by a mobile terminal. The apparatus 400 includes an entering module 401, a broadcasting module 402, a receiving module 403, an establishing module 404, and a sending module 405.

The entering module 401 is configured to, when detecting a switching instruction, enter an Access Point (AP) mode.

The broadcasting module 402 is configured to broadcast a LAN signal after entering the AP mode.

The receiving module 403 is configured to receive an access request message sent by a mobile terminal according to the LAN signal.

The establishing module 404 is configured to establish a LAN connection with the mobile terminal.

The sending module 405 is configured to send a control program for controlling the apparatus 400 to the mobile terminal via the LAN connection.

In some embodiments, the control program is a program developed based on the fifth amended HyperText Markup Language HTML5, and the control program is compatible with a mobile operating system, such as an iOS platform or an Android platform.

Consistent with the embodiments of the present disclosure, when the mobile terminal does not successfully download the control program for controlling the apparatus 400 from the internet, the apparatus 400 receives an access request message sent by the mobile terminal, establishes a LAN connection with the mobile terminal, and sends the control program for controlling the apparatus 400 to the mobile terminal through the LAN connection. Even if the mobile terminal fails to download the control program for controlling the apparatus 400 from the internet, the mobile terminal can download it from the apparatus 400.

With respect to the devices in the above embodiments, the specific manners for performing operations of the individual modules therein have been described in detail in the embodiments of the methods.

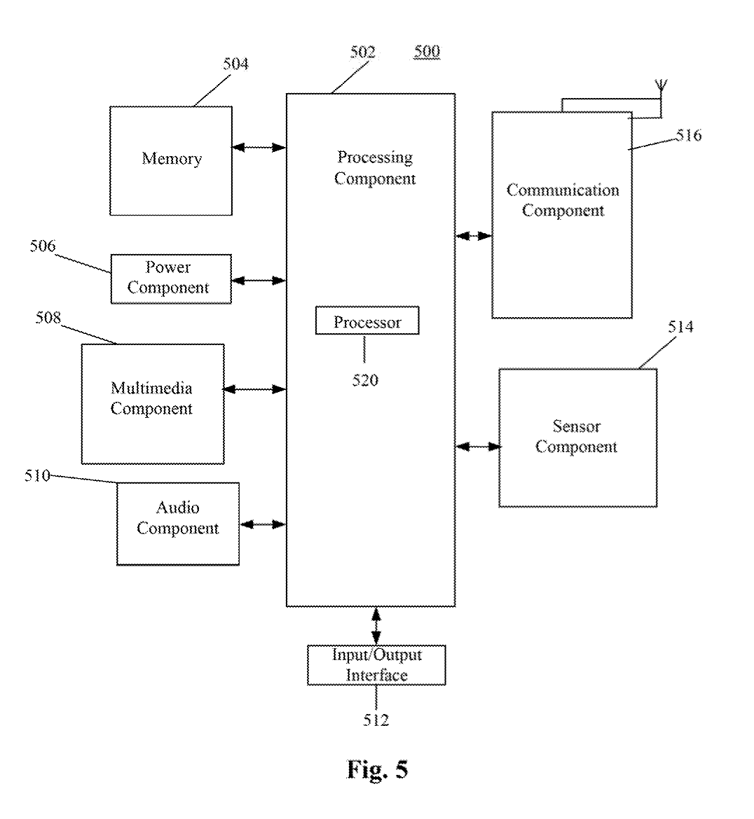

FIG. 5 is a block diagram of a device 500 for downloading a control program, according to one exemplary embodiment of the present disclosure. For example, the device 500 may be a mobile phone, a computer, a digital broadcast terminal, a messaging device, a gaming console, a tablet, a medical device, exercise equipment, a personal digital assistant, and the like.

Referring to FIG. 5, the device 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls overall operations of the device 500, such as the operations associated with display, telephone calls, data communications, camera operations, and recording operations. The processing component 502 may include one or more processors 520 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the device 500. Examples of such data include instructions for any applications or methods operated on the device 500, contact data, phonebook data, messages, pictures, video, etc. The memory 504 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the device 500. The power component 506 may include a power management system, one or more power sources, and any other components associated with the generation, management, and distribution of power in the device 500.

The multimedia component 508 includes a screen providing an output interface between the device 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. The front camera and/or the rear camera may receive an external multimedia datum while the device 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone configured to receive an external audio signal when the device 500 is in an operation mode, such as a call mode, a recording mode, and a voice recognition mode. The received audio signal may be further stored in the memory 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the device 500. For instance, the sensor component 514 may detect an open/closed status of the device 500, relative positioning of components, e.g., the display and the keypad, of the device 500, a change in position of the device 500 or a component of the device 500, a presence or absence of user contact with the device 500, an orientation or an acceleration/deceleration of the device 500, and a change in temperature of the device 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the device 500 and other devices. The device 500 can access a wireless network based on a communication standard, such as WiFi, 2G, 3G, 4G or a combination thereof. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 500 may be implemented with one or more application specific integrated circuits (ASICs), digital signal processors (DSPs), digital signal processing apparatuses (DSPDs), programmable logic apparatuses (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 504, executable by the processor 520 in the device 500, for performing the above-described methods. For example, the non-transitory computer-readable storage medium may be a ROM, a RAM, a CD-ROM, a magnetic tape, a floppy disc, an optical data storage apparatus, and the like.

A non-transitory computer-readable storage medium, when instructions in the storage medium is executed by the processor of the device 500, enables the device 500 to perform a method of downloading a control program, the method including: receiving a Local Area Network (LAN) signal sent by a device to be controlled after the device enters an Access Point (AP) mode; establishing a LAN connection with the device to be controlled according to the LAN signal; and downloading a control program of controlling the device to be controlled from the device to be controlled through the LAN connection.

In some embodiments, the control program includes at least a control interface and a control command for controlling the device to be controlled. The control interface includes at least one control port corresponding to one or more control commands in the control program, and the method further includes: receiving a user selection of the control port in the control interface, acquiring the control command corresponding to the control port, and sending the acquired control command to the device to be controlled via the LAN, such that the device to be controlled can execute the acquired control command.

In some embodiments, the method includes: when it is determined that downloading the control program for controlling the device to be controlled via internet is unsuccessful, receiving the LAN signal sent by the device to be controlled after the device enters the AP mode.

In some embodiments, the method includes: if it is determined that downloading the control program for controlling the device to be controlled via the internet is unsuccessful, issuing prompt information for notifying a user that downloading the control program is unsuccessful; if detecting a user instruction of changing the manner of acquiring control program, receiving the LAN signal sent by the device to be controlled after entering the AP mode.

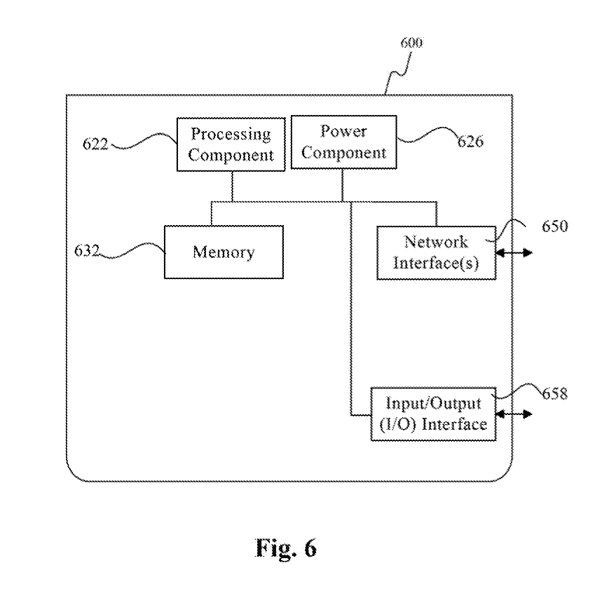

FIG. 6 is a block diagram of a device 600 for downloading a control program, according to an exemplary embodiment. For example, the device 600 may be a device to be controlled. Referring to FIG. 6, the device 600 includes a processing component 622 that further includes one or more processors, and memory resources represented by a memory 632 for storing instructions, such as application programs, executable by the processing component 622. The application programs stored in the memory 632 may include one or more modules, each of them corresponding to a set of instructions. Further, the processing component 622 is configured to execute the instructions to perform the above described method.

The device 600 may also include a power component 626 configured to perform power management of the device 600, wired or wireless network interface(s) 650 configured to connect the device 600 to a network, and an input/output (I/O) interface 658. The device 600 may operate based on an operating system stored in the memory 632, such as Windows Server™, Mac OS X™, Unix™, Linux™, FreeBSD™, or the like.

If detecting a switching instruction, the device 600 enters an access point (AP) mode. The device 600 broadcasts a LAN signal after entering the AP mode. The device 600 receives an access request message sent by a mobile terminal according to the LAN signal. The device 600 establishes a LAN connection with the mobile terminal. The device 600 sends a control program for controlling the device 600 to the mobile terminal via the LAN connection.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a first device to download a control program, comprising:
receiving a Local Area Network (LAN) signal sent by a second device to be controlled after the second device enters an Access Point (AP) mode;
establishing a LAN connection with the second device according to the LAN signal; and
downloading the control program for controlling the second device from the second device through the LAN connection.

2. The method according to claim 1, wherein the control program includes at least a control interface and a control command for controlling the second device, the control interface including at least one control port corresponding to one or more control commands in the control program, and the method further comprises:
receiving a user selection of a control port in the control interface;
acquiring a control command corresponding to the selected control port; and
sending the acquired control command to the second device via the LAN connection, such that the second device executes the acquired control command.

3. The method according to claim 1, wherein, before receiving the LAN signal sent by the second device, the method further comprises:
determining whether downloading the control program for controlling the second device via an interne is unsuccessful.

4. The method according to claim 1, further comprising:
if it is determined that downloading the control program for controlling the second device via an internet is unsuccessful, issuing prompt information for notifying a user that downloading the control program for controlling the second device via internet is unsuccessful; and
if a user instruction of changing a manner of acquiring the control program is detected, receiving the LAN signal sent by the second device after the second device enters the AP mode.

5. The method according to claim 1, wherein the control program is developed based on a fifth amended HyperText Markup Language (HTML5), and the control program is compatible with a mobile operating system.

6. An apparatus for downloading a control program, comprising:
a processor; and
a memory for storing instructions executable by the processor;
wherein the processor is configured to:
receive a Local Area Network (LAN) signal sent by a device to be controlled after the device enters an Access Point (AP) mode;
establish a LAN connection with the device according to the LAN signal; and
download the control program for controlling the device from the device through the LAN connection.

7. The apparatus according to claim 6, wherein
the control program includes at least a control interface and a control command for controlling the device, the control interface including at least one control port corresponding to one or more control commands in the control program, and the processor is further configured to:
receive a user selection of a control port in the control interface;
acquire a control command corresponding to the selected control port; and
send the acquired control command to the device via the LAN, such that the device executes the acquired control command.

8. The apparatus according to claim 6, wherein before receiving the LAN signal sent by the device, the processor is further configured to determine whether downloading the control program for controlling the device via an internet is unsuccessful.

9. The apparatus according to claim 6, wherein the processor is further configured to:
if it is determined that downloading the control program for controlling the device via an internet is unsuccessful, issue prompt information for notifying a user that downloading the control program of controlling the device via the internet is unsuccessful; and
if a user instruction of changing a manner of acquiring the control program is detected, receive the LAN signal sent by the device after the device enters the AP mode.

10. The apparatus according to claim 6, wherein the control program is developed based on a fifth amended HyperText Markup Language (HTML5), and the control program is compatible with a mobile operating system.

11. A device, comprising:
a processor; and
a memory for storing instructions executable by the processor;
wherein the processor is configured to:
detect a switching instruction;
enter an Access Point (AP) mode;
broadcast a LAN signal after entering the AP mode;
receive an access request message sent by a mobile terminal according to the LAN signal;
establish a LAN connection with the mobile terminal; and
send a control program for controlling the device to the mobile terminal via the LAN connection.

12. The device according to claim 11, wherein the control program is developed based on a fifth amended HyperText Markup Language (HTML5), and the control program is compatible with a mobile operating system.
